(19) United States
(12) Patent Application Publication
(10) Pub. No.: US 2007/0188293 A1
(43) Pub. Date: Aug. 16, 2007

(54) Temperature switch

(76) Inventor: Yu-Kang Yang, Yung-Kang City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/355,485

(22) Filed: Feb. 16, 2006

(51) Int. Cl. H01H 37/52

(52) U.S. Cl. 337/400; 337/333

(57) ABSTRACT

A temperature switch includes a housing, a switching unit installed in the housing and including a resilient movable conductive plate that is movable between on and off positions, and a temperature control unit mounted on the housing and including a heat-conductive cover that is adapted to conduct heat of a heating element, a temperature-responsive element abutting against the cover, and a control rod and a fuse element disposed between the temperature-responsive element and the movable conductive plate to be moved by the temperature-responsive element so as to contact the movable conductive plate. The control rod has two opposite ends respectively extending towards the temperature-responsive element and the movable conductive plate. The fuse element is disposed at one of the ends. When the fuse element is melted, the control rod is disconnected from the temperature-responsive element either structurally or functionally.

### BACKGROUND OF THE INVENTION

1. Field of the Invention

The invention relates to a temperature switch, more particularly to a temperature switch that has a temperature-sensing capability for controlling supply of power.

2. Description of the Related Art

Referring to FIGS. 1 to 3, a conventional temperature switch includes a porcelain housing 11. The housing 11 has a bottom wall 111, and a surrounding wall 113 that projects upwardly from an outer periphery of the bottom wall 111 and that cooperates with the same to define a receiving space 112. The bottom wall 111 has a stepped portion 114. The conventional temperature switch further includes opposite first and second conductors 12, 13 disposed below the bottom wall 111 and connected electrically and respectively to two electrical wires 22, 23, a first conductive plate 14 disposed in the receiving space 112 and extending through the bottom wall 111 so as to connect electrically with the first conductor 12, a second conductive plate 15 disposed in the receiving space 112 and extending through the stepped portion 114 so as to connect electrically with the second conductor 13, a resilient movable conductive plate 16 disposed in the receiving space 112 and abutting against the first conductive plate 14, a rod-support seat 17 mounted on the surrounding wall 113, a porcelain control rod 18 extending slidably in a hole in the rod-support seat 17, a temperature-responsive element 19 disposed in the rod-support seat 17 and abutting against the control rod 18, and a metal cover 10 disposed on top of the rod-support seat 17 so as to cover the housing 11 and abutting against a heating element 21 of an electrical appliance (not shown). The movable conductive plate 16 has a contact part 161 located below the second conductive plate 15, and a dome-shaped portion 162 disposed below and abutting against the control rod 18. The second conductive plate 15 has a downwardly projecting contact part 151 for contacting the contact part 161 of the movable conductive plate 16. The temperature-responsive element 19 has a curved portion 191 which deforms when reaching a preset deformation temperature. The preset deformation temperature is set as needed and may be either hot or cold. For example, the temperature switch installed in an electric iron requires a high deformation temperature, while the temperature switch installed in a drinking dispenser requires a low deformation temperature.

When the temperature switch is in an “on” position, as shown in FIG. 2, the curved portion 191 of the temperature-responsive element 19 opens downwardly, and is in contact with the cover 10. Furthermore, the control rod 18 is disposed between the curved portion 191 of the temperature-responsive element 19 and the dome-shaped portion 162 of the movable conductive plate 16. Power is supplied through the electrical wire 22, such that electrical current associated therewith passes through the first conductor 12, the first conductive plate 14, the movable conductive plate 16, the second conductive plate 15, the second conductor 13, and into the electrical wire 23.

Assuming a high (hot) preset deformation temperature when heat of the heating element 21 is transmitted from the cover 10 to the temperature-responsive element 19, and the preset deformation temperature is reached, the curved portion 191 of the temperature-responsive element 19 will deform from opening downwardly shown in FIG. 2 to opening upwardly shown in FIG. 3. As a result, the curved portion 191 downwardly biases the control rod 18, which in turn downwardly biases the movable conductive plate 16 so as to move the contact part 161 of the movable conductive plate 16 away from the contact part 151 of the second conductive plate 15. As such, electrical current cannot flow from the first conductive plate 14 to the second conductive plate 15, thereby placing the temperature switch at an “off” position.

Although the aforementioned conventional temperature switch can achieve its intended purpose, when movable cooperation between components is not smooth, or when the curved portion 191 of the temperature-responsive element 19 fails to deform when the preset deformation temperature is reached, the “off” state of the temperature switch cannot be obtained. Furthermore, to enhance safe use of the electrical appliance, some manufacturers add a fuse to one of the electrical wires 22, 23. However, this complicates assembly of the conventional temperature switch.

### SUMMARY OF THE INVENTION

Therefore, the object of the present invention is to provide a temperature switch that is capable of overcoming the aforementioned drawbacks of the prior art.

According to this invention, a temperature switch comprises an insulation housing, a switching unit installed in the housing, and a temperature control unit mounted on the housing. The switching unit includes a resilient movable conductive plate that is movable between on and off positions. The temperature control unit includes a heat-conductive cover that is adapted to conduct heat of a heating element, a temperature-responsive element abutting against the heat-conductive cover, a control rod, and a fuse element. The control rod and the fuse element are disposed between the temperature-responsive element and the movable conductive plate to be moved by the temperature-responsive element so as to contact the movable conductive plate. The control rod has two opposite ends respectively extending towards the temperature-responsive element and the movable conductive plate. The fuse element is disposed at one of the ends. When the fuse element is melted, the control rod is disconnected from the temperature-responsive element either structurally or functionally.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a conventional temperature switch;

FIG. 2 is a fragmentary sectional view of the conventional temperature switch in an assembled state, illustrating the conventional temperature switch in an “on” position;

FIG. 3 is a view similar to FIG. 2, but with the conventional temperature switch in an “off” position;

FIG. 4 is an exploded perspective view of the first preferred embodiment of a temperature switch according to the present invention;

FIG. 5 is a fragmentary sectional view of the first preferred embodiment in an assembled state, illustrating the temperature switch of the present invention in an “on” position;

FIG. 6 is a view similar to FIG. 5, but illustrating the temperature switch of the present invention in an “off” position;

FIG. 7 is a view similar to FIG. 5, but illustrating a fuse element of the first preferred embodiment in a melted state;

FIG. 8 is a view similar to FIG. 5, but illustrating the second preferred embodiment of a temperature switch according to the present invention; and

FIG. 9 is a view similar to FIG. 5, but illustrating the third preferred embodiment of a temperature switch according to the present invention.

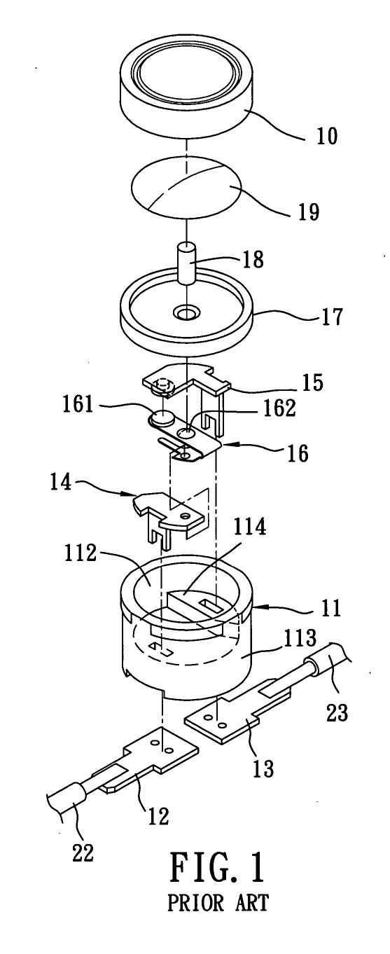

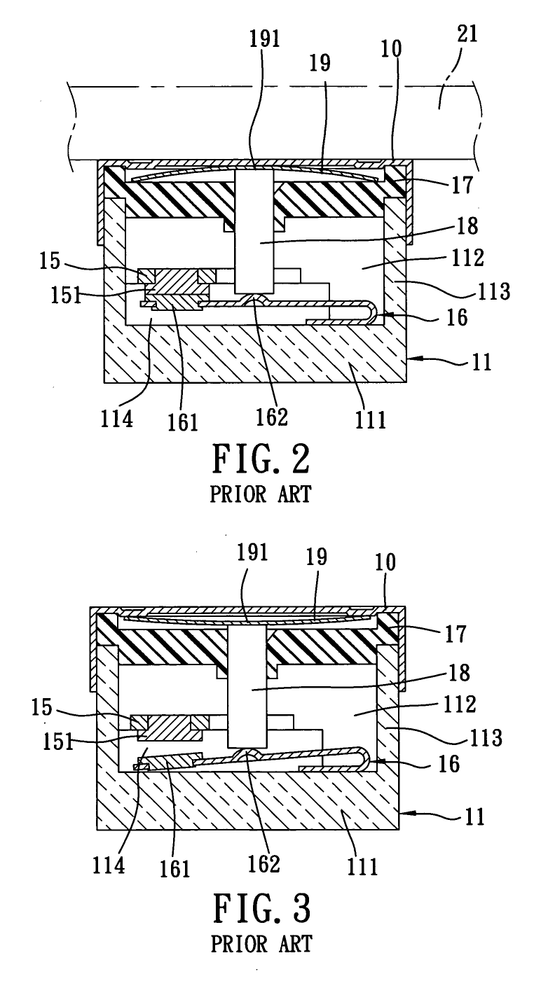

### DETAILED DESCRIPTION OF THE PREFERRED EMBODIMENTS

Before the present invention is described in greater detail, it should be noted that like elements are denoted by the same reference numerals throughout the disclosure.

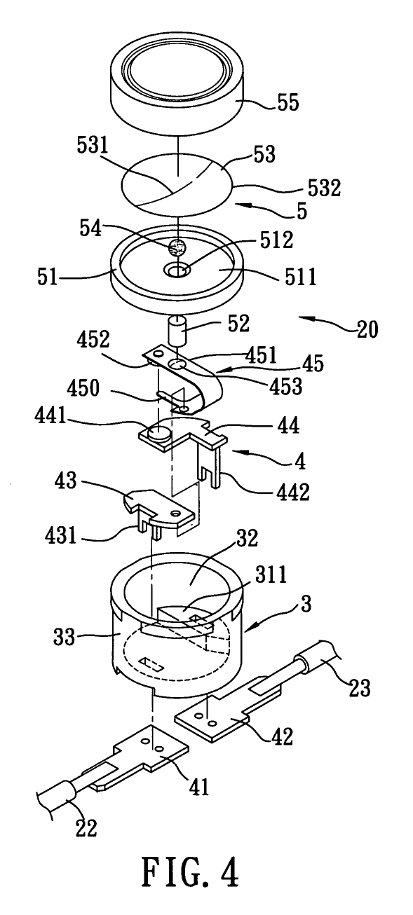

Referring to FIGS. 4 to 7, the first preferred embodiment of a temperature switch 20 according to the present invention is adapted to be installed in an electrical appliance, and is shown to comprise an insulation housing 3, a switching unit 4, and a temperature control unit 5.

The housing 3 is made of porcelain, and includes a bottom wall 31, and a surrounding wall 33 projecting upwardly from an outer periphery of the bottom wall 31 and cooperating with the same to define a receiving space 32. The bottom wall 31 has a stepped portion 311.

The switching unit 4 includes two opposite first and second conductors 41, 42 disposed below the bottom wall 31 and adapted to be connected electrically and respectively to electrical wires 22, 23, a conductive connecting plate 43 disposed within the receiving space 32 and having a downward projection 431 that extends through the bottom wall 31 and that is fixed to the first conductor 41, a fixed conductive plate 44 disposed on the stepped portion 311 and having a downward projection 442 that extends through the bottom wall 31 and that is fixed to the second conductor 42, and a resilient movable conductive plate 45. The fixed conductive plate 44 has an upwardly projecting contact part 441. The movable conductive plate 45 has a curved portion 450 fixed to the bottom wall 31 and abutting against the conductive connecting plate 43, and a resilient portion 451 disposed above the fixed conductive plate 44. The resilient portion 451 has a downwardly projecting contact part 452 located above the contact part 441 of the fixed conductive plate 44, and a dome-shaped part 453 between the curved portion 450 and the contact part 452. In an “off” position of the temperature switch 20, the contact part 452 of the resilient portion 451 is spaced apart from the contact part 441 of the fixed conductive plate 44, and electrical current from the electrical wire 22 can only be transmitted to the conductive connecting plate 43 and the movable conductive plate 45 through the first conductor 41. The electrical current cannot flow to the second conductor 42 through the fixed conductive plate 44 in this state.

A plastic rod-support seat 51 is mounted on top of the surrounding wall 33 of the housing 3, and has a bottom plate 511, and an annular protrusion 513 projecting downwardly from the center of the bottom plate 511 and defining a passage hole 512. The movable conductive plate 45 is located below the rod-support seat 51.

The temperature control unit 5 includes a control rod 52, a temperature-responsive element 53, a fuse element 54, and a heat-conductive cover 55. The control rod 52 is made of porcelain, and extends slidably in the passage hole 512. In this embodiment, the dome-shaped part 453 of the resilient portion 451 of the movable conductive plate 45 is in contact with a bottom end of the control rod 52.

The fuse element 54, in this embodiment, is configured as a tin ball, and is positioned in the passage hole 512.

The temperature-responsive element 53 is formed as a convex disc, and is disposed above the rod-support seat 51. The convex disc has an outer periphery 532, and a convex portion 531 in contact with the fuse element 54. The fuse element 54, in this embodiment, is disposed between a top end of the control rod 52 and the convex portion 531 of the temperature-responsive element 53.

The fuse element 54 has a melting temperature that can be set as needed. Generally, the melting temperature of the fuse element 54 is set between 180˜220° C. The temperature-responsive element 53 has a deformation temperature that can also be set as needed. For example, the deformation temperature can be set at 100° C., 140° C., 180° C., etc.

The heat-conductive cover 55 is disposed above the rod-support seat 51, and is connected to the housing 3 opposite to the bottom wall 31. The cover 55 is adapted to abut against a heating element 21 of an electrical appliance (not shown) so as to conduct heat emanating from the heating element 21. Normally, the outer periphery 532 of the temperature-responsive element 53 is placed in contact with a bottom surface of the cover 55, and the convex portion 531 of the temperature-responsive element 53 extends away from the bottom surface of the cover 55.

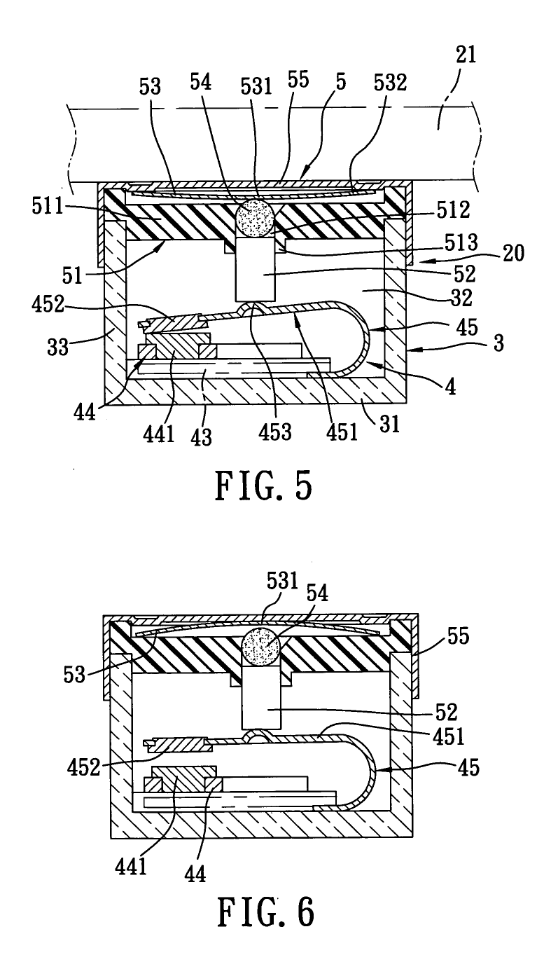

When the temperature switch 20 is in an “on” position, as shown in FIG. 5, the resilient portion 451 of the movable conductive plate 45 is pressed downwardly through coordination of the control rod 52, the temperature-responsive element 53, and the fuse element 54, so that the contact part 452 of the resilient portion 451 abuts against the contact part 441 of the fixed conductive plate 44. At this time, electrical current supplied through the electrical wire 22 passes consecutively through the first conductor 41, the conductive connecting plate 43, the movable conductive plate 45, the fixed conductive plate 44, the second conductor 42, and into the electrical wire 23.

In use, when heat from the heating element 21 is transmitted to the temperature-responsive element 53 through the heat-conductive cover 55, and reaches the deformation temperature of the temperature-responsive element 53, the convex portion 531 of the temperature-responsive element 53 deforms from a state shown in FIG. 5 to another state shown in FIG. 6. At this time, the resilient portion 451 of the movable conductive plate 45 biases upwardly the control rod 52 and the fuse element 54, resulting in movement of the contact part 452 of the resilient portion 451 away from the contact part 441 of the fixed conductive plate 44. This prevents electrical current from flowing to the fixed conductive plate 44, and places the temperature switch 20 in an “off” position, as shown in FIG. 6.

When the temperature reaches another preset value, the convex portion 531 of the temperature-responsive element 53 deforms again from the state shown in FIG. 6 to the state shown in FIG. 5, so that the temperature switch 20 is restored to its “on” position.

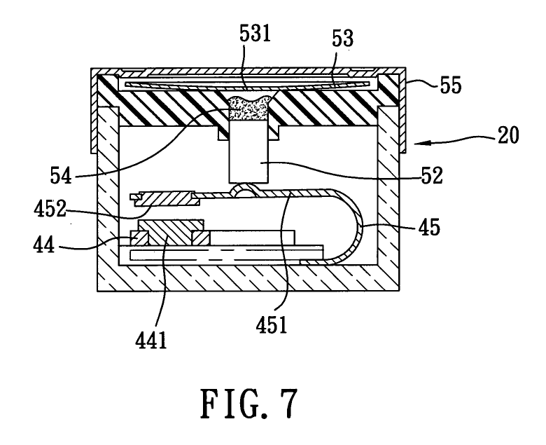

It should be noted that the convex portion 531 of the temperature-responsive element 53 deforms when a preset temperature is reached. However, if the convex portion 531 did not deform as expected due to the abnormal operation of the temperature-responsive element 53, the heat absorbed by the heat-conductive cover 55 will increase continuously until the heat transmitted to the fuse element 54 through the temperature-responsive element 53 reaches the melting point of the fuse element 54, at which point the fuse element 54 will start to melt. Eventually, a gap is produced between the fuse element 54 and the convex portion 531 of the temperature-responsive element 53, as shown in FIG. 7. This will permit the resilient portion 451 of the movable conductive plate 45 to bias upwardly the control rod 52 and move the contact part 452 of the resilient portion 451 away from the contact part 441 of the fixed conductive plate 44, thereby putting the temperature switch 20 in the “off” position. Hence, when the temperature transmitted to the cover 55 is higher than the deformation temperature of the temperature-responsive element 53, but the temperature-responsive element 53 is defective, through the melting of the fuse element 54, the flow of current through the temperature switch 20 can still be prevented. The temperature switch 20 of the present invention, therefore, has a built-in safety function.

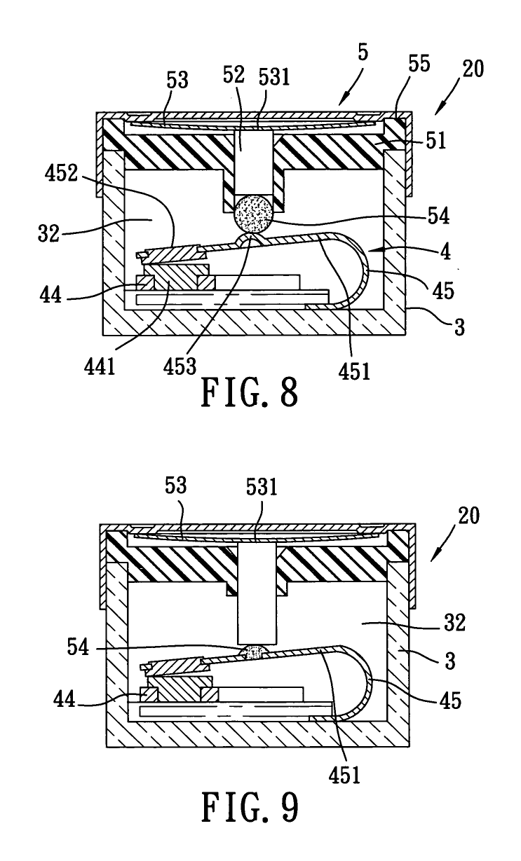

Referring to FIG. 8, the second preferred embodiment of a temperature switch 20 according to the present invention is shown to be similar to the first preferred embodiment. However, in this embodiment, the fuse element 54 is disposed between the bottom end of the control rod 52 and the dome-shaped part 453 of the resilient portion 451 of the movable conductive plate 45. When the temperature inside the receiving space 32 is higher than the melting temperature of the fuse element 54, the fuse element 54 will melt, and a gap will be produced between the control rod 52 and the convex portion 531 of the temperature-responsive element 53. This will permit the resilient portion 451 of the movable conductive plate 45 to bias upwardly, which in turn results in movement of the contact part 452 of the resilient portion 451 away from the contact part 441 of the fixed conductive plate 44.

Referring to FIG. 9, the third preferred embodiment of a temperature switch 20 according to the present invention is shown to be similar to the second preferred embodiment. However, in this embodiment, the fuse element 54 is configured as a stud or a rivet fixed to there silient portion 451 of the movable conductive plate 45. Similarly, when the temperature inside the receiving space 32 is higher than the melting temperature of the fuse element 54, the fuse element 54 will melt and permit there silient portion 451 of the movable conductive plate 45 to bias upwardly and away from the fixed conductive plate 44.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A temperature switch comprising:
an insulation housing;
a switching unit installed in said housing, and including a resilient movable conductive plate that is movable between on and off positions; and
a temperature control unit mounted on said housing, and including a heat-conductive cover that is adapted to conduct heat of a heating element, a temperature-responsive element abutting against said heat-conductive cover, a control rod, and a fuse element, said control rod and said fuse element being disposed between said temperature-responsive element and said movable conductive plate to be moved by said temperature-responsive element so as to contact said movable conductive plate, said control rod having two opposite ends respectively extending towards said temperature-responsive element and said movable conductive plate, said fuse element being disposed at one of said ends;
wherein when said fuse element is melted, said control rod is disconnected from said temperature-responsive element either structurally or functionally.

2. The temperature switch of claim 1, further comprising a rod-support seat, said heat-conductive cover and said temperature-responsive element being disposed above said rod-support seat, said movable conductive plate being located below said rod-support seat, said rod-support seat having a passage hole, said control rod extending slidably in said passage hole.

3. The temperature switch of claim 2, wherein said fuse element is positioned in said passage hole on top of said control rod and in contact with said temperature-responsive element.

4. The temperature switch of claim 2, wherein said fuse element is positioned in said passage hole beneath said control rod and in contact with said movable conductive plate.

5. The temperature switch of claim 2, wherein said fuse element is disposed beneath said control rod, and is fixed to said movable conductive plate.

6. The temperature switch of claim 5, wherein said fuse element is formed as a stud fixed to said movable conductive plate and projecting from said movable conductive plate toward said control rod.

7. The temperature switch of claim 2, wherein said temperature-responsive element is formed as a convex disc, said convex disc having an outer periphery placed in contact with a bottom surface of said heat-conductive cover, and a convex portion extending away from said bottom surface and contacting one of said ends of said control rod and said fuse element.

8. The temperature switch of claim 7, wherein said housing includes a bottom wall, and a surrounding wall projecting upwardly from said bottom wall, said heat-conductive cover being connected to said housing opposite to said bottom wall.

9. The temperature switch of claim 8, wherein said switching unit further includes a fixed conductive plate, said movable and said fixed conductive plates being mounted on said bottom wall, said fixed conductive plate having a fixed contact part to contact said movable conductive plate.
